(19) United States
(12) Patent Application Publication
(10) Pub. No.: US 2010/0153946 A1
(43) Pub. Date: Jun. 17, 2010

(54) DESKTOP SOURCE TRANSFER BETWEEN DIFFERENT POOLS

(75) Inventors: Arun Kumar BHASKAR, Bangalore (IN); Raghavendra Babu B R, Bangalore (IN); Sivaprasad K. Govindankutty, Bangalore (IN)

Correspondence Address: VMWARE, INC., DARRYL SMITH, 3401 Hillview Ave., PALO ALTO, CA, 94304, US

(73) Assignee: VMware, Inc., Palo Alto, CA (US)

(21) Appl. No.: 12/336,974

(22) Filed: Dec. 17, 2008

(51) Int. Cl. G06F 9/455

(52) U.S. Cl. 718/1

(57) ABSTRACT

A method, apparatus, and system of desktop source transfer between different pools are disclosed. In one embodiment, a machine-readable medium includes determining that a transfer request is associated with a desktop source, accessing the desktop source from a source pool, and automatically transferring the desktop source from the source pool to a destination pool.

### RELATED APPLICATIONS

This application is related to U.S. application Ser. No. ______ (Docket No. A307), entitled “Policy Management to Initiate an Automated Action on a Desktop Source” and U.S. application Ser. No. ______ (Docket No. A306), entitled “Network Administration in a Virtual Machine Environment Through a Temporary Pool.”

### FIELD OF TECHNOLOGY

This disclosure relates generally to an enterprise method, a technical field of software and/or hardware technology and, in one example embodiment, to desktop source transfer between different pools.

### BACKGROUND

A virtual machine may be referred to as a desktop source when the virtual machine is associated with a user and an operating system (e.g., the desktop source may also be a physical system or a blade server associated with the user and the operating system). A data center may include various groupings of virtual machines called pools. An administrative cost may increase when underutilized pools have to be maintained. An administrator may need to relocate desktop sources from one pool to another (e.g., because of organizational changes, load balancing reasons, etc.).

For example, the administrator may need to relocate desktop sources from an underutilized pool to one with greater utilization to minimize administrative complexity. To do this, the administrator may need to manually delete desktop sources from the underutilized pool and recreate them in the pool with greater utilization. During a process of deleting desktop sources from one pool and recreating them in different pools, a session state of the desktop source may be lost. As a result, the process of deleting and recreating desktop sources may be time consuming, frustrating and/or expensive.

### SUMMARY

In one aspect, a machine-readable medium embodying a set of instructions that, when executed by a machine, causes the machine to perform a method determines that a transfer request is associated with a desktop source. The machine-readable medium accesses the desktop source from a source pool, and automatically transfers the desktop source from the source pool to a destination pool.

In another aspect, a system is disclosed. A virtual machine server of a data center hosts the virtual machine pools. A connection server determines that a transfer request is associated with a desktop source on the virtual machine server to access the desktop source from a source pool on the virtual machine server. The connection server automatically transfers the desktop source from the source pool to a destination pool. In addition, a set of client devices accesses the virtual machines on the virtual machine server through the connection server.

In yet another aspect, a machine-readable medium embodying a set of instructions that, when executed by a machine, causes the machine to perform a method includes determining configuration information of a desktop source of a source pool. The machine-readable medium duplicates the desktop source of the source pool on a destination pool based on the configuration information. In addition, the machine-readable medium processes a confirmation that the duplication from the source pool to the destination pool is complete. The machine-readable medium also verifies that the duplication of the desktop source on the destination pool is functional, and deletes the desktop source on the source pool when the duplication is verified as being functional on the destination pool.

### BRIEF DESCRIPTION OF THE DRAWINGS

FIG. 1 is a system view of a virtual view manager environment, according to one or more embodiments.

FIG. 2 is an exploded view of different pools illustrating the transfer mechanism of a desktop source between pools, according to one or more embodiments.

FIG. 3 is a system view of a Virtual Infrastructure illustrating client devices, connection servers and the desktop sources, according to one or more embodiments.

FIG. 4 is an user interface view illustrating a manual pool including the desktop sources, according to one or more embodiments.

FIG. 5 is a process flow illustrating the transfer of the desktop source between existing pools, according to one or more embodiments.

### DETAILED DESCRIPTION

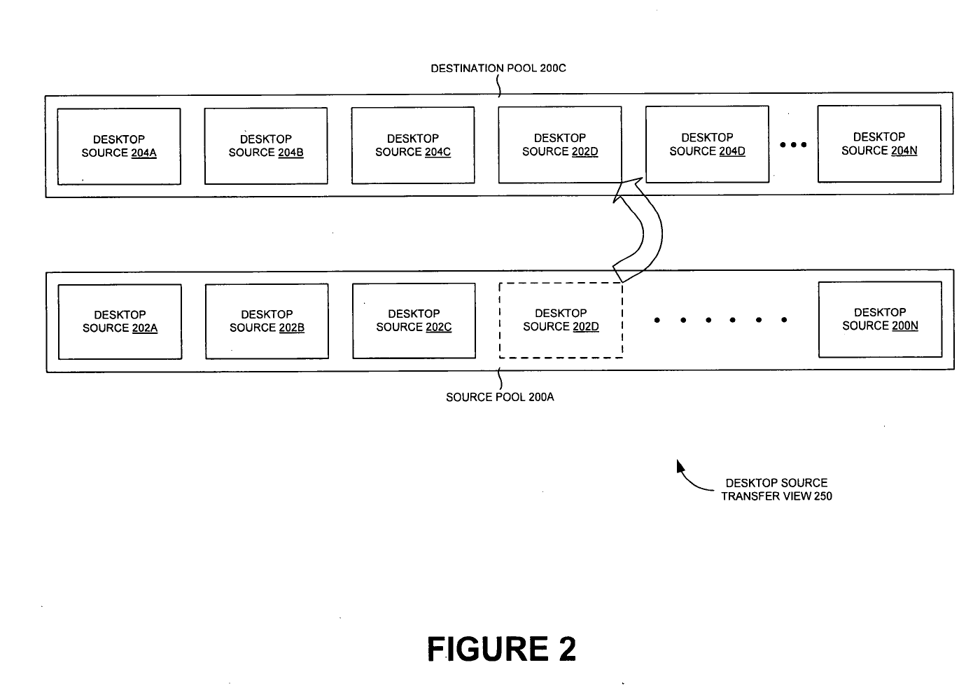

In one embodiment, a machine-readable medium embodying a set of instructions that, when executed by a machine, causes the machine to perform a method includes determining that a transfer request is associated with a desktop source (e.g., the desktop source 202D of FIG. 2), accessing the desktop source 202D from a source pool (e.g., the source pool 200A of FIG. 2), and automatically transferring the desktop source 202D from the source pool 200A to a destination pool (e.g., the destination pool 200C of FIG. 2).

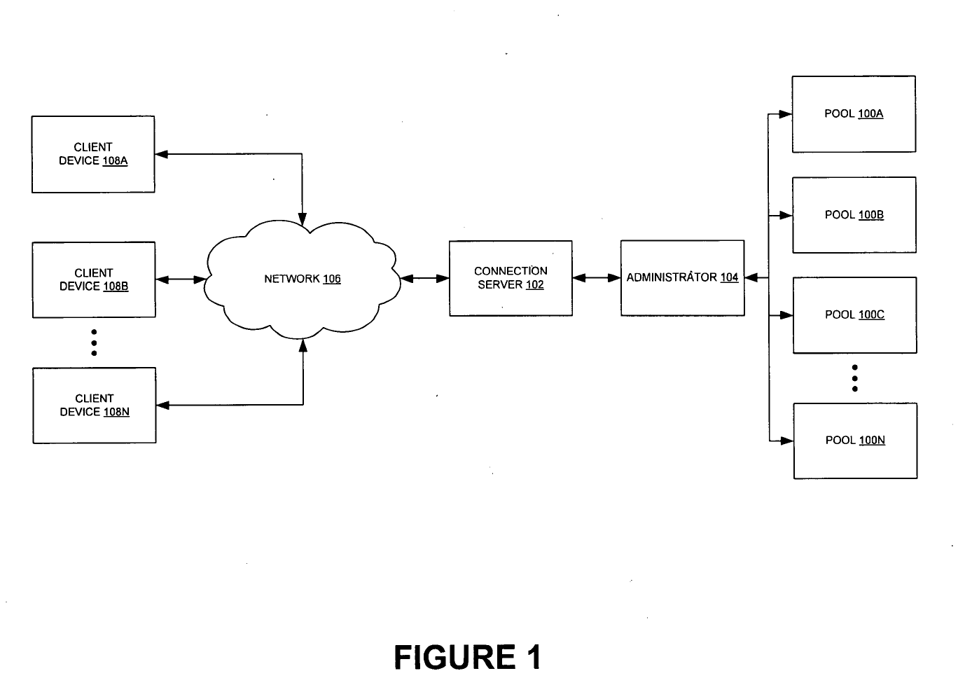

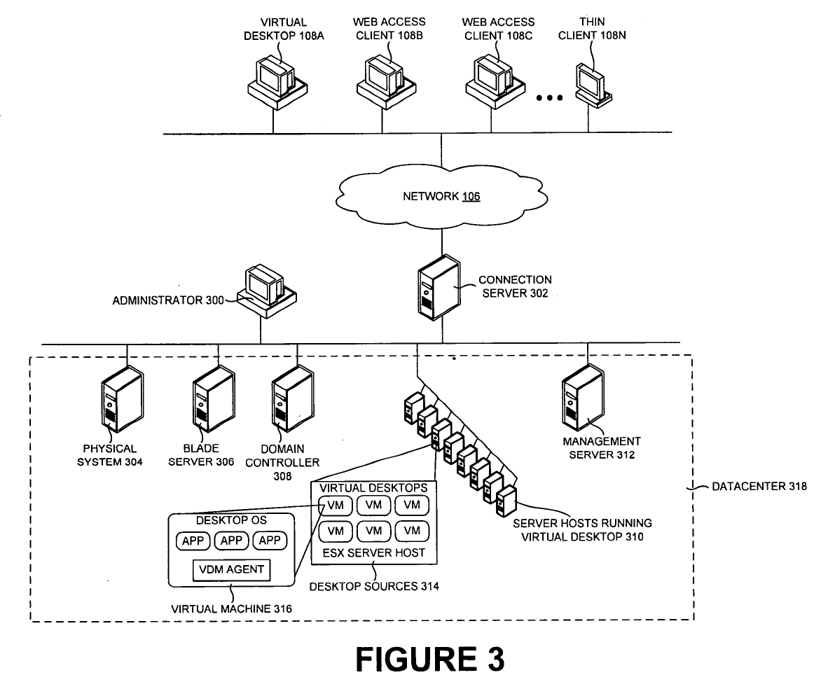

In another embodiment, a system includes a virtual machine server (e.g., the virtual machine server 310 of FIG. 3) of a data center (e.g., the data center 318 of FIG. 3) that hosts a plurality of virtual machine pools (e.g., the pool 100A-N of FIG. 1), a connection server (e.g., the connection server 102 of FIG. 1) to determine that that a transfer request is associated with a desktop source (e.g., the desktop source 202D of FIG. 2) on the virtual machine server 310, to access the desktop source 202D from a source pool (e.g., the source pool 200A of FIG. 2), on the virtual machine server 310, and to automatically transfer the desktop source 202D from the source pool 200A to a destination pool (e.g., the destination pool 200C of FIG. 2), and a set of client devices 108A-N to access the plurality of virtual machines 316 on the virtual machine server 310 through the connection server 102.

In yet another embodiment, a machine-readable medium embodying a set of instructions that, when executed by a machine, causes the machine to perform a method includes determining a configuration information of a desktop source (e.g., the desktop source 202D of FIG. 2) of a source pool (e.g., the source pool 200A of FIG. 2), duplicating the desktop source 202D of the source pool 200A on a destination pool (e.g., the destination pool 200C of FIG. 2) based on the configuration information, processing a confirmation that the duplication from the source pool 200A to the destination pool 200C is complete, verifying that the duplication of the desktop source 202D on the destination pool 200C is functional, and deleting the desktop source 202D on the source pool 200A when the duplication is verified as being functional on the destination pool 200C.

FIG. 1 is a system view of a virtual view manager environment, according to one or more embodiments. Particularly, FIG. 1 illustrates a pool 100A-N, a connection server 102, an administrator 104, a network 106, and a client device 108A-N, according to one embodiment.

The pool 100A-N may include the group of desktop sources which may be assigned to the end user (e.g., the client device 108A-N). The connection server 102 may enable the authorized end-users (e.g., the client device 108A-N) to securely connect to the centralized virtual desktop, back-end physical systems and/or the terminal servers in the datacenter 318 of FIG. 3. Based on the enterprise requirements the administrator 300 may manage and monitor the desktop sources (e.g., the desktop sources 204A-N to 202A-N) using various delivery models and/or pools. The administrator 104 may be accessible from a remote location through a web browser and can perform various activities like pool management, configuration changes, manage entitlements, rights and policies, etc.

The network 106 may be the conjoined computers that can share storage devices, peripherals, and applications. Networks may be connected directly by cable connection, or indirectly by telephone lines or satellites, and can be part of a small-office system or global web of numerous other networks, The client device 108A-N may be the windows client, the Linux™ web access, the MAC web access, the thin client that may access the desktop source in the data center of the virtual environment.

In example embodiment, the client devices 108A-B may connected to the network 106 to access pools 100A-N through the connection server 102 and the administrator 104.

FIG. 2 is an exploded view of different pools illustrating the transfer mechanism of a desktop source between pools, according to one or more embodiments. Particularly, FIG. 2 illustrates a source pool 200A, a destination pool 200C, desktop sources 204A-N, and desktop sources 202A-N, according to one embodiment.

FIG. 2 illustrates the desktop source transfer view 250, according to one embodiment. The source pool 200A may be a pool (e.g., an individual pool, a manual desktop pool, an automated desktop pool, a terminal pool, etc.) from which the desktop source 202D is transferred to the destination pool 200C. The destination pool 200C may be a pool which may include group of desktop sources (e.g., virtual machines, physical systems, etc.) which may share a common attribute with the source pool.

The desktop sources 204A-N and/or desktop sources 202A-N may be one or more virtual machines, the physical systems 304 of FIG. 3 and a blade server 306 of FIG. 3 associated with a user (e.g., the client device 108A) and an operating system. The desktop sources 202A-N also may be the same virtual machines, the physical systems and a blade server associated with a user (e.g., the client device 108A) and an operating system in another set of pool (e.g., the destination pool 200C). The desktop source 202D may be required to move from one source pool 200A to the destination pool 200C.

In an example embodiment, the source pool 200A and the destination pool 200C may include the desktop sources 204A-N and the desktop sources 202A-N.

In one embodiment, the transfer request may be determined associated with the desktop source (e.g., the desktop source 202D). The desktop source 202D from a source pool 200A may be accessed and automatically transferred from the source pool 200A to the destination pool 200C. The source pool 200A and the destination pool 200C are groupings of virtual machines 316 sharing a common attribute. The source pool 200A and the destination pool 200C may be a non-persistent pool in which users are not assigned to the specific desktop source (e.g., the desktop sources 204A-N and/or the desktop sources 202A-N) and when the user is logged off the desktop source (e.g., the desktop sources 204A-N and/or the desktop sources 202A-N), the desktop source (e.g., the desktop sources 204A-N and/or the desktop sources 202A-N) is returned to the non-persistent pool and made available to other users.

The session state of the user may be maintained when the source pool 200A and the destination pool 200C is the persistent pool. The desktop source (e.g., the desktop sources 204A-N and/or the desktop sources 202A-N) may be the virtual machine 316, the physical system 304, and the blade server 306 associated with a user (e.g., the client 108A-N) and an operating system. The common attribute may be an organization, a functional role, an application configuration, and the operating system. The virtual machine server (e.g., the server host 310) of the data center 318 may host one or more of virtual machine pools. The connection server 102 may determine that the transfer request is associated with a desktop source 202D on the virtual machine server and may access the desktop source 202D from the source pool 200A on the virtual machine. In addition the connection server 102 may automatically transfer the desktop source 202D from the source pool 200A to the destination pool 200C.

The client devices 108A-N may access the virtual machines 316 on the virtual machine server through the connection server 302. The source pool 200A and the destination pool 200C are groupings of virtual machines sharing a common attribute. The configuration information of the desktop source 202D of the source pool 200A may be determined and the desktop source 202D of the source pool 200A may be duplicated on the destination pool 200C based on the configuration information. In addition, the confirmation may be processed that the duplication from the source pool 200A to the destination pool 200C is complete.

The duplication of the desktop source 202D may be verified on the destination pool 200C. The desktop source 202D on the source pool 200A may be deleted when the duplication is verified as being functional on the destination pool 200C.

FIG. 3 is a system view of a Virtual Infrastructure illustrating client devices, connection servers and the desktop sources, according to one or more embodiments.

Particularly, FIG. 3 illustrates an administrator 300, a connection server 302, a physical system 304, a blade server 306, a domain controller 308, a server host running virtual desktop 310, a management server 312, desktop sources 314, a virtual machine 316, a data center 318, the network 106 and the clients 108A-N, according to one embodiment.

The administrator 300 may be the central location of the virtual environment where all the configuration, deployment and administrative tasks related to the management of the client and the datacenter is performed. The connection server 302 may enable the authorized end-users (e.g., the client's 108A-N) to securely connect to the centralized virtual desktop, back-end physical systems and/or the terminal servers in the datacenter. The physical system 304 (e.g., may be a physical computer) may be a hardware-based device with an operating system such as a personal computer. The term is generally used to differentiate hardware-based computers from software-based virtual machines.

The blade server 306 may be self-contained computer servers, designed for high density. A blade enclosure may hold multiple blade servers, providing services such as power, cooling, networking, various interconnects and management. Together these form the blade system. The blade system may be intended to address the needs of large-scale computing centers to reduce space requirements and lower costs. The domain controller 308 may be a server that responds to security authentication requests (e.g., logging in, checking permissions, etc.) within the domain. The domain controller 308 may also provide a variety of network services including LDAP-like Directory Services. LDAP is an application protocol for querying and modifying directory services running over TCP/IP.

The server host 310 may be the server in the data center of the virtual machine environment that may run the virtual desktop. The management server 312 may be a virtual center that may provide the operating virtual machines and may also monitor the performance of physical servers and virtual machines. The desktop sources 314 may be the virtual machine, the physical system, blade server that is associated with the end user and the operating system. The virtual machine 316 may be a type of computer application (e.g., hardware operating virtual machine software) that may be used to create a virtual environment (e.g., virtualization) and may be used to run multiple operating systems at the same time. The data center 318 may include various groupings of virtual machines called pools.

In an example embodiment, the client devices 108A-N may access the virtual machine 316, the physical system 304, the blade server 306, and the domain controller 308 using the network 106 and the connection server 302. The management server 312 may manage the virtual desktop (e.g., the desktop sources 314) that may include the desktop OS (e.g., the virtual machine). The administrator 300 may manage the deployment and management of the desktop sources 314 in the pool.

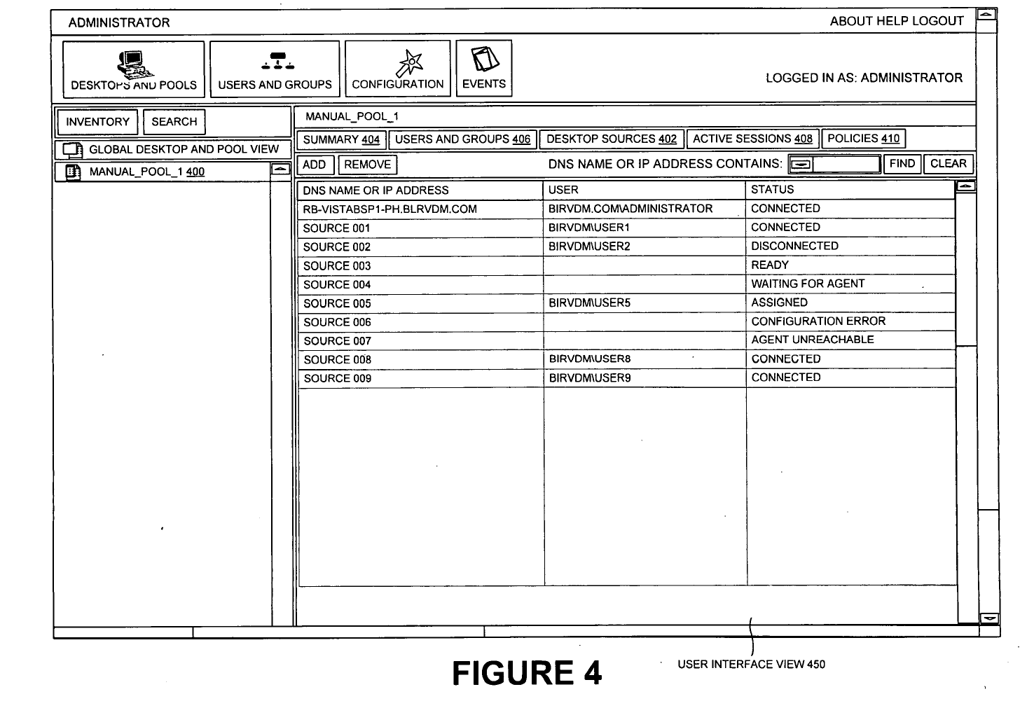

FIG. 4 is a user interface view illustrating a manual pool including the desktop sources, according to one or more embodiments. The user interface view 450 illustrates the manual pool 400 according to one embodiment. For example, the manual pool 400 that may include the desktop sources 402A-N are illustrated. The desktop source 402 may be the virtual machine, the physical system, blade server that is associated with the end user and the operating system. The tabs in the user view 450 may be a summary 404, users and groups 406, the desktop sources 402A-N, an active sessions 408 and policies 410. The summary tab 404 may give the detail description of the desktop sources 402A-N and its associated user. The users and groups 406 may indicate the number of user associated with the pool. The active sessions 408 may indicate the session state (e.g., the idle state, the active state, the used state, etc.) of the desktop source 402A-N in the pool. The policies 410 may be the user defined policies, the organization defined and the system defined policies.

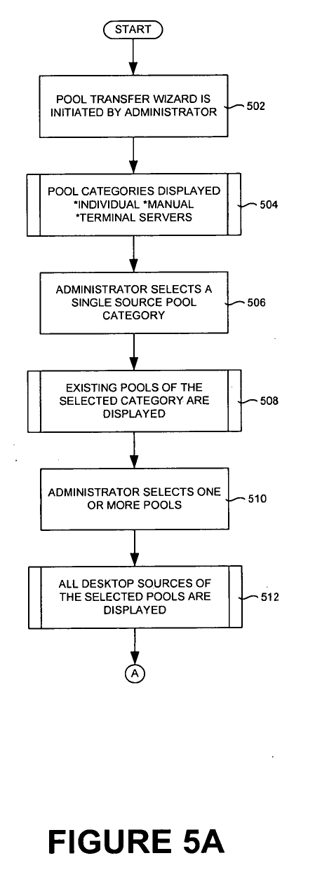

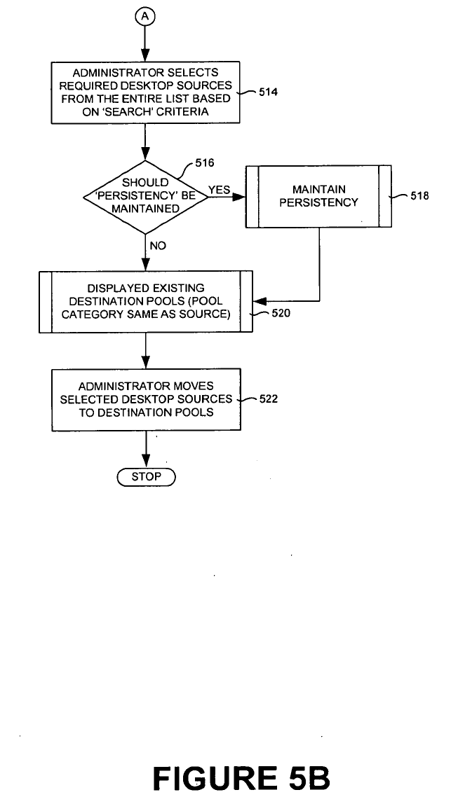

FIG. 5 is a process flow illustrating the transfer of the desktop source between existing pools, according to one or more embodiments. In operation 502, the administrator 104 may initiate the pool transfer wizard. In operation 504, the pool categories may be displayed. The categories such as the individual desktop pool, the manual desktop pool, an automated desktop pool and the terminal server pool are displayed. In operation 506, the administrator 104 may select the single source pool 200A category from where the desktop source 202D has to be transferred. In operation 508, the destination pool 200C categories may be displayed. In operation 510, the administrator 104 may select the destination pool 200C where the desktop source 202D has to be transferred. In operation 512, all the desktop sources 202A-N from the source pool 200A may be displayed

In operation 514, the administrator 104 may select the required desktop source (e.g., the desktop source 202D) from the entire list of various pools based on the search criteria. In operation 516, the administrator 104 may give an option to maintain persistency. In operation 518, as per the confirmation, the persistency of desktop source 202D may be maintained. Persistency means keeping a specific desktop source assigned to a specific user. In operation 520, the existing destination pools (e.g., the destination pool 200C) may be displayed. In operation 522, the administrator 104 may move the selected desktop source (e.g., the desktop source 202D) to the destination pool 200C.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In one or more embodiments, programming instructions for executing above described methods and systems are provided. The programming instructions are stored in a computer readable media.

With the above embodiments in mind, it should be understood that one or more embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of one or more embodiments of the invention are useful machine operations. One or more embodiments of the invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic, JavaScript™, PHP, XML, HTML etc., or a combination of programming languages. Commonly available protocols such as SOAP/HTTP may be used in implementing interfaces between programming modules. As would be known to those skilled in the art the components and functionality described above and elsewhere herein may be implemented on any desktop operating system such as different versions of Microsoft Windows™, Apple Mac™, Unix/X-Windows™, Linux™, etc., executing in a virtualized or non-virtualized environment, using any programming language suitable for desktop software development.

The programming modules and ancillary software components, including configuration file or files, along with setup files required for providing the method and apparatus for troubleshooting subscribers on a telecommunications network and related functionality as described herein may be stored on a computer readable medium. Any computer medium such as a flash drive, a CD-ROM disk, an optical disk, a floppy disk, a hard drive, a shared drive, and storage suitable for providing downloads from connected computers, could be used for storing the programming modules and ancillary software components. It would be known to a person skilled in the art that any storage medium could be used for storing these software components so long as the storage medium can be read by a computer system.

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

One or more embodiments of the invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

While one or more embodiments of the present invention have been described, it will be appreciated that those skilled in the art upon reading the specification and studying the drawings will realize various alterations, additions, permutations and equivalents thereof. It is therefore intended that embodiments of the present invention include all such alterations, additions, permutations, and equivalents as fall within the true spirit and scope of the invention as defined in the following claims. Thus, the scope of the invention should be defined by the claims, including the full scope of equivalents thereof.

What is claimed is:

1. A machine-readable medium embodying a set of instructions that, when executed by a machine, causes the machine to perform a method, comprising:
determining that a transfer request is associated with a desktop source;
accessing the desktop source from a source pool; and
automatically transferring the desktop source from the source pool to a destination pool.

2. The machine-readable medium of claim 1 wherein the source pool and the destination pool are groupings of virtual machines sharing a common attribute.

3. The machine-readable medium of claim 2 wherein the desktop source is at least one of a virtual machine, a physical system, and a blade server associated with a user and an operating system.

4. The machine-readable medium of claim 3 wherein the common attribute is at least one of an organization, a functional role, an application configuration, and the operating system.

5. The machine-readable medium of claim 2 wherein at least one of the source pool and the destination pool is a non-persistent pool in which users are not assigned to a specific desktop source, wherein when a user is logged off the desktop source, the desktop source is returned to the non-persistent pool and made available to other users.

6. The machine-readable medium of claim 2 wherein at least one of the source pool and the destination pool is a persistent pool in which users are assigned to the desktop source, wherein when a user is logged on the desktop source, a same desktop source is accessed each instance.

7. The machine-readable medium of claim 6 wherein a session state of the user is maintained when at least one of the source pool and the destination pool is the persistent pool.

8. A system, comprising:
a virtual machine server of a data center that hosts a plurality of virtual machine pools;
a connection server to determine that a transfer request is associated with a desktop source on the virtual machine server, to access the desktop source from a source pool on the virtual machine server, and to automatically transfer the desktop source from the source pool to a destination pool; and
a set of client devices to access the plurality of virtual machines on the virtual machine server through the connection server.

9. The system of claim 8 wherein the source pool and the destination pool are groupings of virtual machines sharing a common attribute.

10. The system of claim 9 wherein the desktop source is a virtual machine associated with a user and an operating system.

11. The system of claim 10 wherein the common attribute is at least one of an organization, a functional role, an application configuration, and the operating system.

12. The system of claim 9 wherein at least one of the source pool and the destination pool is a non-persistent pool in which users are not assigned to a specific desktop source, wherein when a user is logged off the desktop source, the desktop source is returned to the non-persistent pool and made available to other users.

13. The system of claim 9 wherein at least one of the source pool and the destination pool is a persistent pool in which users are assigned to the desktop source, wherein when a user is logged on the desktop source, a same desktop source is accessed each instance.

14. The system of claim 13 wherein a session state of the user is maintained when at least one of the source pool and the destination pool is the persistent pool.

15. A machine-readable medium embodying a set of instructions that, when executed by a machine, causes the machine to perform a method, comprising:
determining a configuration information of a desktop source of a source pool;
duplicating the desktop source of the source pool on a destination pool based on the configuration information;
processing a confirmation that the duplication from the source pool to the destination pool is complete;
verifying that the duplication of the desktop source on the destination pool is functional; and
deleting the desktop source on the source pool when the duplication is verified as being functional on the destination pool.

16. The machine-readable medium of claim 15 wherein the configuration information includes operating system, driver, and application information associated with the desktop source.

17. The machine-readable medium of claim 15 wherein the source pool and the destination pool are groupings of virtual machines sharing a common attribute, and wherein the desktop source is a virtual machine associated with a user and an operating system.

18. The machine-readable medium of claim 17 wherein the common attribute is at least one of an organization, a functional role, an application configuration, and the operating system.

19. The machine-readable medium of claim 16 wherein at least one of the source pool and the destination pool is a non-persistent pool in which users are not assigned to a specific desktop source, wherein when a user is logged off the desktop source, the desktop source is returned to the non-persistent pool and made available to other users.

20. The machine-readable medium of claim 16:
wherein at least one of the source pool and the destination pool is a persistent pool in which users are assigned to the desktop source, wherein when a user is logged on the desktop source, a same desktop source is accessed each instance, and
wherein a session state of the user is maintained when at least one of the source pool and the destination pool is the persistent pool.
